(19) United States
(12) Patent Application Publication
(10) Pub. No.: US 2025/0111373 A1
(43) Pub. Date: Apr. 3, 2025

(54) SYSTEMS AND METHODS FOR FRAUD PREVENTION

(71) Applicant: Capital One Services, LLC, McLean, VA (US)

(72) Inventors: Jayanth Prathipati, Aldie, VA (US); Daniel Pick, Falls Church, VA (US); Colin Hart, Falls Church, VA (US)

(21) Appl. No.: 18/479,543

(22) Filed: Oct. 2, 2023

(51) Int. Cl. G06Q 20/40; G06Q 20/10

(52) U.S. Cl. CPC G06Q 20/4016; G06Q 20/10; G06Q 20/4015

(57) ABSTRACT

Disclosed embodiments may include a method for fraud prevention. The method may include receiving a login request for an account associated with a user and a geolocation of the user device, and determining whether the geolocation of the user device falls outside of a known customer geographic region. In responsive to determining the geolocation of the user falls outside of the known customer geographic region, the method may include transmitting a request for a first step-up authentication information to the user device, receiving, via the user device, the first step-up authentication information using one or more step-up authentication methods, and determining whether the first step-up authentication information matches known first step-up authentication information. In response to determining that the first step-up authentication information matches a known first step-up authentication information, the method may include authorizing the user device to access the account of the user.

### FIELD

The disclosed technology relates to systems and methods for fraud prevention. Specifically, this disclosed technology relates to preventing fraud by utilizing one or more authentication methods when a user's device is outside a known customer geographic region.

### BACKGROUND

Fraud prevention methods do not take into account a geolocation of a user device to when determining which authentication method to require from a user. Requiring authentication methods that are inaccessible can be frustrating for users and ultimately cause users to refrain from accessing their account information, conducting transactions, and the like.

Accordingly, there is a need for improved systems and methods for fraud prevention. Embodiments of the present disclosure are directed to this and other considerations.

### SUMMARY

Disclosed embodiments may include a system for fraud prevention. The system may include one or more processors, and memory in communication with the one or more processors and storing instructions that, when executed by the one or more processors, are configured to cause the system to prevent fraud. The system may receive a login request for an account associated with a user and a geolocation of the user device, determine whether the geolocation of the user device falls outside of a known customer geographic region, responsive to determining that the geolocation is not outside of a known customer geographic region, authorize the user device to access the account of the user based on the login request, and responsive to determining the geolocation of the user falls outside of the known customer geographic region: transmit a request for a first step-up authentication information to the user device, receive, via the user device, the first step-up authentication information using one or more step-up authentication methods, determine whether the first step-up authentication information matches known first step-up authentication information, responsive to determining that the first step-up authentication information matches a known first step-up authentication information, authorize the user device to access the account of the user, and responsive to authorizing the user device to access the account of the user: receive, via the user device, a funds transfer request, determining whether the funds transfer request exceeds an amount threshold, and responsive to determining that the funds transfer request exceeds the amount threshold: transmit a request for a second step-up authentication information to the user device, receive, via the user device, the second step-up authentication information using the one or more step-up authentication methods, determine whether the second step-up authentication information matches known second step-up authentication information, and responsive to determining that the second step-up authentication information matches known second step-up authentication information, authorize the user device to transfer funds in the account of the user.

Disclosed embodiments may include a system for fraud prevention. The system may include one or more processors, and memory in communication with the one or more processors and storing instructions that, when executed by the one or more processors, are configured to cause the system to prevent fraud. The system may receive, via a user device, a login request for an account associated with a user and a geolocation of the user device, determine whether the geolocation of the user device falls outside of a known customer geographic region, responsive to determining that the geolocation is not outside of a known customer geographic region, authorize the user device to access the account of the user based on the login request, and responsive to determining the geolocation of the user falls outside of the known customer geographic region: transmit a request for a step-up authentication information to the user device, receive, via the user device, set-up authentication information using one or more step-up authentication methods, determine whether the step-up authentication information matches known step-up authentication information, and responsive to determining that the step-up authentication information matches known step-up authentication information, authorize the user device to access the account of the user.

Disclosed embodiments may include a method for fraud prevention. The method may include receiving a login request for an account associated with a user and a geolocation of a user device of the user, determining a geolocation of the user device falls outside of a known customer geographic region, transmitting a request for a step-up authentication information to the user device, receiving set-up authentication information using one or more step-up authentication methods comprising at least silent mobile authentication, determining whether the step-up authentication information matches known step-up authentication information, and responsive to determining that the step-up authentication information matches known step-up authentication information, authorizing the user device to access the account of the user.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIGS. 1A and 1B are flow diagrams illustrating an exemplary method for fraud prevention in accordance with certain embodiments of the disclosed technology.

FIG. 2 is a flow diagram illustrating an exemplary method for fraud prevention in accordance with certain embodiments of the disclosed technology.

FIG. 3 is block diagram of an example fraud prevention system used to provide fraud prevention, according to an example implementation of the disclosed technology.

FIG. 4 is block diagram of an example system that may be used to provide fraud prevention, according to an example implementation of the disclosed technology.

### DETAILED DESCRIPTION

Examples of the present disclosure related to systems and methods for fraud prevention. More particularly, the disclosed technology relates to preventing fraud by sending authentication methods to a user when the user's device is outside a known customer geographic region. The systems and methods described herein utilize, in some instances, machine learning models, which are necessarily rooted in computers and technology. Machine learning models are a unique computer technology that involves training models to complete tasks and make decisions. The present disclosure may include sending authentication methods based on the finding of a machine learning model to a user when the user device is outside of the known customer geographic region. This, in some examples, may involve using actions associated with an account as input data and a machine learning model, applied and trained to analyze the different actions associated with an account and assigning different risk levels to each action, and outputs a result of an appropriate authentication method to use based on the action associated with the account based in part on the account history. Using a machine learning model in this way may allow the system to choose an appropriate authentication method depending on the risk level of the action a user would like to complete on an account associated with the user. This is a clear advantage and improvement over prior technologies that regularly utilize one time passwords regardless of the risk level of the action the user would like to complete because when a user is outside of the country, access to a known user device or being able to receive a one-time password may not be possible. Requiring an authentication method that is not easily completed for the user or by the user can compromise the user's experience, especially when the user is outside of the country. The present disclosure solves this problem by using a machine learning model to determine the best authentication method, or whether multiple authentication methods should be enforced at different times depending on the action the user wishes to complete with the account of the user. Furthermore, examples of the present disclosure may also improve the speed with which computers can complete authentication methods because certain authentication methods may be preferable over others depending on the history of the account and the risk level of the action that the user is completing. Overall, the systems and methods disclosed have significant practical applications in the fraud prevention field because of the noteworthy improvements of the machine learning model using actions as data inputs to dynamically assign risk levels and to select an appropriate authentication method based on the action, which is important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

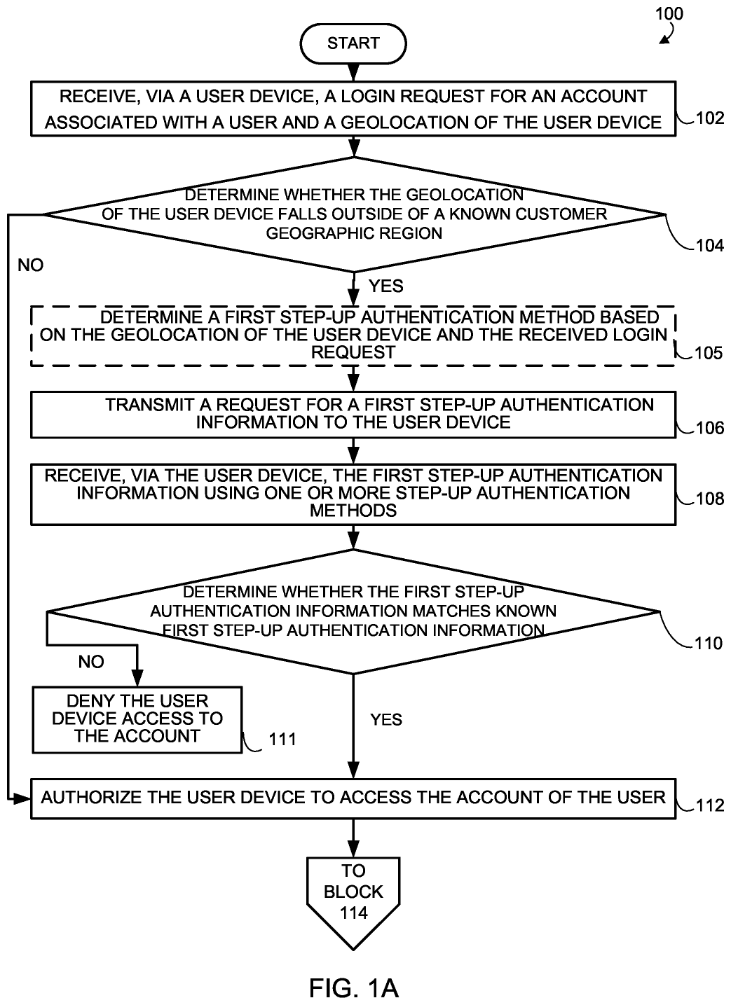

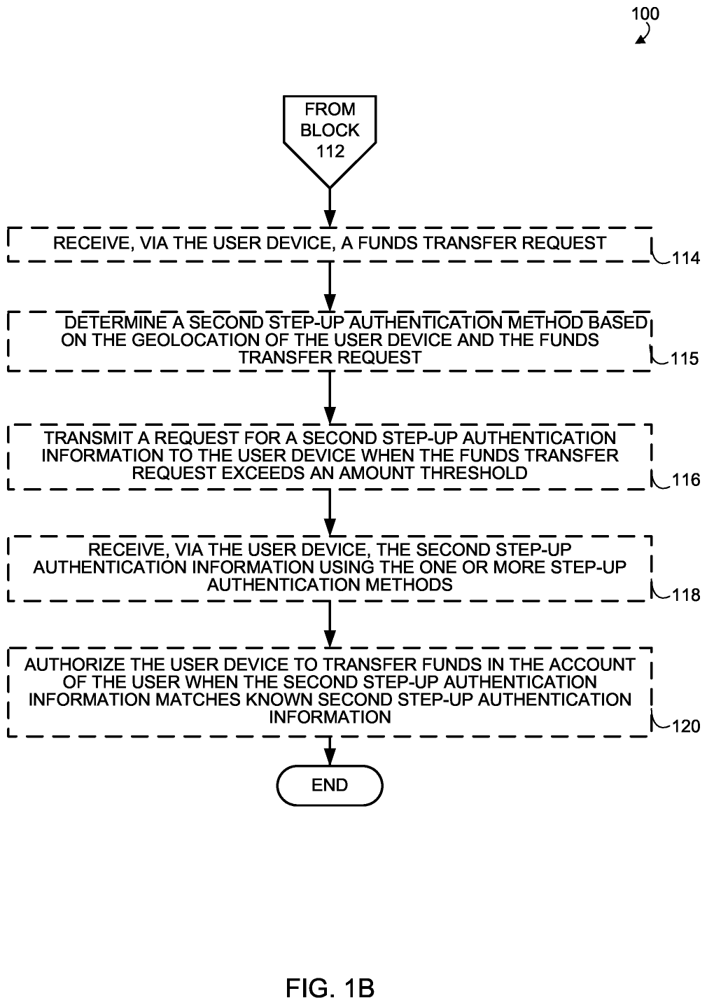

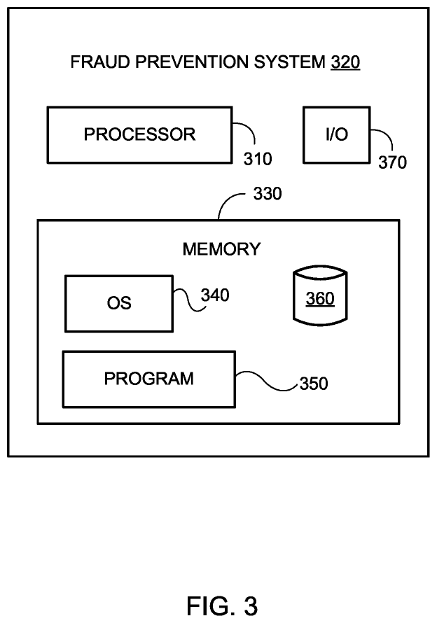

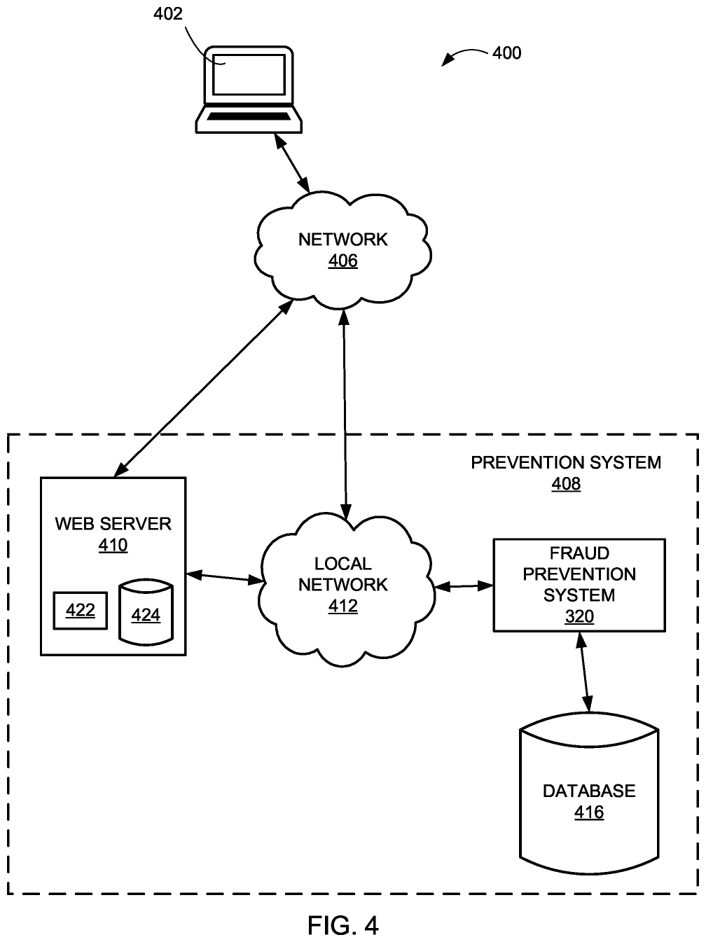

FIGS. 1A and 1B are flow diagrams illustrating an exemplary method 100 for fraud prevention, in accordance with certain embodiments of the disclosed technology. The steps of method 100 may be performed by one or more components of the system 400 (e.g., fraud prevention system 320 or web server 410 of prevention system 408 or user device 402), as described in more detail with respect to FIGS. 3 and 4.

In block 102, the fraud prevention system 320 may receive, via a user device 402, a login request for an account associated with a user and a geolocation of the user device 402. The login request and geolocation may be sent via the user device 402. The login request can be a request to access the account associated with the user. For example, the account may be a bank account and the login request can be a request to login to the bank account to complete banking transactions or to verify banking information. The geolocation of the user device 402 can be sent via the user device 402 as well. The geolocation may indicate the location of the user device 402 such as the real time location of the user device 402. In some embodiments, the geolocation has pinpoint accuracy of the user device 402 at any given point in time. In some embodiments, the internet protocol (IP) address of the user device 402 can be used by the fraud prevention system 320 to estimate the location of the user device 402. In some embodiments, information from the service provider of the user device 402, Bluetooth™, low-energy Bluetooth™ (BLE), WiFi™, and GPS are received from the user device 402 and are used by the fraud prevention system 320 to pinpoint the location of the user device 402. In some embodiments, transactions on the account may help indicate that a user is outside of a known customer geographic region, and it can be required to proceed with additional authentication methods, even if the user device 402 falls inside of a known customer geographic region. For example, if transactions on the account indicate that the user is out of the country, and the user device 402 is seeking to access the account from within a known customer geographic region, additional authentication methods will be required, and notifications can be sent by e.g., the fraud prevention system 320, to known user devices (e.g., user device 402 and/or others) or email addresses associated with the user. The notifications may include a request to verify the authorizations of the transactions on the account of the user.

In block 104, the fraud prevention system 320 may determine whether the geolocation of the user device 402 falls outside of a known customer geographic region. The fraud prevention system 320 can have a plurality of known customer geographic regions associated with the account of the user stored in a database such as database 416. The plurality of known customer geographic regions can comprise of locations where the user has authenticated a known user device 402 and associated the known user device (e.g., user device 402 and/or others) with the account of the user. The plurality of known customer geographic regions can also comprise of addresses and locations provided by the user to be associated with the account of the user. For each known customer geographic region of the plurality of known customer geographic regions, the fraud prevention system 320 may create a known customer geographic region by including a predetermined size region in the database surrounding a provided address, known location, or previously authenticated user device location. If the fraud prevention system 320 determines that the geolocation of the user device 402 falls outside of a known customer geographic region, the fraud prevention system 320 proceeds to block 106. The fraud prevention system 320 can determine that the geolocation falls outside or inside of the known customer geographic location by comparing the geolocation coordinates to the known customer geographic regions stored in the database such as database 416. If the geolocation is within a predetermined range of one of the known customer geographic regions of the plurality of known customer geographic regions, then the fraud prevention system 320 may conclude that the user device 402 falls inside of the known customer geographic region. Otherwise, if the fraud prevention system 320 determines that the geolocation of the user device 402 does not fall outside of a known customer geographic region, then the fraud prevention system 320 proceeds to block 112. The fraud prevention system 320 proceeds to block 112 to authorize the user device 402 to access the account of the user based on the login request without the need for additional authentication methods. For example, if the user is outside of the country or is overseas, then additional authentication methods are necessary to protect the account of the user. If the user is at home, within a known customer geographic region, additional authentication methods may not be necessary.

In optional block 105, the fraud prevention system 320 may determine a first step-up authentication method based on the geolocation of the user device 402 and the received login request. The fraud prevention system 320 may utilize one or more machine learning trained to select an appropriate authentication method from among two or more authentication methods described below by providing the one or more machine learning models with data representing successful and unsuccessful authentication methods based on geolocations and login requests. For example, if a user is outside of a known customer geographic region, requesting a known password associated with the account may not provide the appropriate level of security desired. In another example, the fraud prevention system 320 may determine that using a one-time password verification may be difficult or limited if the geolocation of the user device 402 is outside of the country. Texting abilities may be limited for the user due to the geolocation of the user device 402. Therefore, the fraud prevention system 320 may refrain from selecting the one-time password verification as a first step-up authentication method due to these limitations and instead select another step-up authentication method described herein. Similarly, if a user device 402 is outside of the country, the user may have limited access to a known email addresses associated with the account of the user. The fraud prevention system 320 may determine that due to the geolocation of the user device 402, email verification should not be selected as the first step-up authentication method. In other examples, due to the low risk nature of the login request, depending on the geolocation of the user device 402, the fraud prevention system 320 may select email verification as the first step-up authentication method. For example, if the user device 402 is still within the country associated with its billing information, but not within a known customer geographic region, the fraud prevention system 320 may select email verification as the first step-up authentication method because the user may still have access to the known email address within the country. In some examples, using near field communication verification, mobile application verification, or silent mobile authentication as outlined below in block 108 may be more desirable based on the geolocation of the user device 402 and the received login request. In this example, if the geolocation of the user device 402 is outside of the country and considering that the current action the user is completing is a login request, the fraud prevention system 320 may select or recommend to the user, either the near field communication verification, the mobile application verification, the silent mobile authentication, or any combinations thereof.

In block 106, the fraud prevention system 320 may transmit a request for a first step-up authentication information to the user device 402. In other words, responsive to determining the geolocation of the user falls outside of the known customer geographic region, the fraud prevention system 320 may transmit a request for a first step-up authentication information to the user device 402 in order to authenticate the user device 402 before allowing the user device 402 access to the account of the user. The request may be sent in order to confirm that the user is authorized to access the account. The first step-up authentication information can include any data that can be used to verity the user's true identity. The first step-up authentication information can differ depending on the step-up authentication method of one or more step-up authentication methods utilized to confirm the identity of the user as explained below in block 108.

In block 108, the fraud prevention system 320 may receive, via the user device 402, the first step-up authentication information using one or more step-up authentication methods. In some embodiments, the first step-up authentication information may include a password received from the user device 402. The known first step-up authentication may include a known password associated with the account of the user. The fraud prevention system 320 may compare the password received from the user device 402 to the known password associated with the account to confirm if the user device 402 should be allowed to access the account of the user.

The one or more step-up authentication methods may include verification with a near field communication enabled card, mobile application verification, email verification, or combinations thereof. The one or more step-up authentication methods may include verification with the near field communication enabled card when the near field communication enabled card contacts a near field communication receiving portion of the user device 402. Near field communication verification involves using short range magnetic field communication between the user device 402 and a near field communication enabled card when they are brought in close proximity or touched. In some embodiments, a card such as a banking card may be a near field communication enabled card. The banking card may be used to verify that the user has authority to access the account of the user. In this example, the first step-up authentication information can comprise of data that indicates that the near field communication enabled card is associated with the account of the user. When the near field communication enabled card is in close proximity or contacts a near field communication receiving portion of the user device 402, the first step-up authentication information will indicate that the near field communication enabled card is associated or not associated with the account of the user. If the near field communication enabled card is new or has not been activated for a long time, this verification method can be less reliable, so a different one of the one or more step-up authentications may be selected and used.

The one or more step-up authentication methods may include silent mobile authentication. The silent mobile authentication may include receiving a telephone number of the user device 402, and determining whether the telephone number matches a phone number associated with the user. A database can have a plurality of phone numbers associated with the user or user's account. Silent mobile authentication can be completed without additional information or actions from the user. In this example, the first step-up authentication information will indicate whether the telephone number of the user matches one of the plurality of phone numbers associated with the user. Silent mobile authentication can also include receiving signal data by the fraud prevention system 320 and the telephone number of the user device 402 from a service provider of the user device 402 to check against the plurality of phone numbers associated with the account of the user. Receiving the information from the service provider can be useful because it can permit the completion of the verification without the user having to provide additional information through the user device 402. If the telephone number has not been associated with the account of the user for a predetermined amount of time, or in other words, if the telephone number is a new number associated with the account, this method may be less reliable and a different one of the one or more step-up authentication methods may be selected and utilized by the fraud prevention system 320.

The one or more step-up authentication methods may further include mobile application verification. The mobile application verification may include sending, by or initiated by the fraud prevention system 320, a notification to a known user device (e.g., user device 402 and/or another user device) of the user. The notification may include a request to authorize access of the account by the user device 402. The notification can also be sent to the known user device 402 through an application on the known user device 402. The fraud prevention system 320 can then receive a response from the known user device 402 to the request to authorize access of the account. The user can choose to deny or authorize the request to authorize access of the account via user device 402. In this example, the first step-up authentication information may include the response from the user to deny or authorize the request. In response to determining that the response denies access of the account by the user device 402, the fraud prevention system 320 can deny the user device 402 to access to the account of the user. In response to determining that the response authorizes access of the account by the user device 402, the fraud prevention system 320 may authorize the user device 402 to access the account of the user.

The one or more step-up authentication methods may include email verification. The email verification may include the fraud prevention system 320 sending an email to an email address of the user. A plurality of email addresses may be associated with the user or an account of the user. The plurality of email addresses can be stored in a database such as database 416. The email verification may include sending the email to one of the plurality of email addresses. The email may include a request to authorize access of the account by the user device 402. The user can decide whether to deny or authorize access of the account by the user device 402. In this example, the first step-up authentication information may include the response from the user to deny or authorize the request. The fraud prevention system 320 may then receive a response from the email address to the request to authorize access of the account. In response to determining that the response denies access of the account by the user device 402, the fraud prevention system 320 may deny the user device 402 to access to the account of the user. Otherwise, in response to determining that the response authorizes access of the account by the user device 402, the fraud prevention system 320 may authorize the user device 402 to access the account of the user.

In some embodiments, the one or more step-up authentication methods may include one-time passwords. A known one-time password can be sent to a known user device 402 associated with the account. If the user device 402 sends the fraud prevention system 320 a one-time password as the first step-up authentication information, then the one-time password received from the user device 402 may be compared to the known one-time password to confirm if the user device 402 has authorization to access the account. This one or more step-up authentication may sometimes fail if the user device 402 is out of the country because the one-time password may not reach the known user device 402 due to the known user device 402 being outside of the country or in an inaccessible area. For example, text messaging may be disabled or blocked in different countries. In this example, the one-time password may not reach the user via the known user device 402. For example, a national carrier may have a contract with international carriers in different countries, which would permit text messaging abroad. However, if a national carrier of a user does not have a contract to use the network of an international carrier in a geographic location, then this can result in text messaging being disabled or blocked in the geographic location.

In block 110, the fraud prevention system 320 may determine whether the first step-up authentication information matches known first step-up authentication information. If the fraud prevention system 320 determines that the first step-up authentication information matches known first step-up authentication information, then the fraud prevention system 320 proceeds to block 112. Otherwise, if the fraud prevention system 320 determines that the first step-up authentication information does not match known first step-up authentication information, then the fraud prevention system 320 does not authorize the user device 402 to access the account of the user. As mentioned above, the first step-up authentication information may include data that can be compared to known first step-up authentication information. For example, with near field communication verification, the first step-up authentication information may include data extracted from the near field communication enabled card contacting a near field communication receiving portion of the user device 402. This first step-up authentication information can be compared to known first step-up authentication information. The fraud prevention system 320 may compare the data extracted from the near field communication card to known data associated with a known near field communication enabled card associated with the account of the user to verify if the user device 402 should be authorized to access the account. In other embodiments, if silent mobile authentication is utilized, the first step-up authentication information may include the telephone number associated with the user device 402. The known first step-up authentication information may include the plurality of phone numbers associated with the account of the user. The fraud prevention system 320 may compare the telephone number of the user device 402 with each of the plurality of phone numbers associated with the account to determine if the user device 402 should be granted access to the account of the user. In other embodiments, where the one or more step-up authentication method utilized is mobile application verification or email verification, the first step-up authentication information may include the response from the known user device 402 or the response from the email address. In these examples, the known first step-up authentication information may include the plurality of email addresses or the known user devices 402 associated with the account. The fraud prevention system 320 may include the source of the received responses, such as the email address sending the response or the known user device 402 sending the response to confirm that the user device 402 should be granted access to the account. If the fraud prevention system 320 determines that the user device 402 should be granted access to the account using any of the one or more step-up authentication methods, then the fraud prevention system 320 can proceed to block 112. Otherwise, the fraud prevention system 320 should deny access to the user device 402 to the account as shown in block 111.

In block 111, the fraud prevention system 320 may deny the user device 402 access to the account. In some embodiments, the fraud prevention system 320 may generate and transmit a graphical user interface (GUI), a notification, text message, email, or combinations thereof to the user device 402 indicating to the user that the access to the account was denied. The fraud prevention system 320 may utilize one or more machine learning trained to select another appropriate authentication method from among two or more authentication methods described above in block 105 through block 110 by providing the one or more machine learning models with data representing successful and unsuccessful authentication methods based on geolocations and login requests. The machine learning models may eliminate the first step-up authentication method previously selected due to the failure of the authentication. If the user device 402 attempts sending multiple login requests and fails multiple step-up authentication methods, the fraud prevention system 320 may lock the account to prevent potential access of the account by a malicious user.

In block 112, the fraud prevention system 320 may authorize the user device 402 to access the account of the user. Blocks 114, 116, 118, and 120 are optional. The fraud prevention system 320 may terminate the authentication process after authorizing the user device 402 to access the account of the user, or in some embodiments, may proceed to block 114. In response to authorizing the user device 402 to access the account of the user, the fraud prevention system 320 may also proceed to block 114. If the fraud prevention system 320 authorizes the user device 402 to access the account of the user, then the user device 402 may be permitted to take actions with the account such as checking the account balance or transactions related to the account. If the user device 402 attempts to do an action that is risker, such as a funds transfer request or funds transfer over a threshold amount, the fraud prevention system 320 may move on to block 114 below.

Actions that can be taken with the account may be associated or categorized into different action risk levels such as low risk level actions, medium risk level actions, or high risk level actions. For example, checking the balance of the account may be associated as a low risk level action. A funds transfer request may be associated as a high risk level action. Checking the transaction history of the account may be associated as a medium risk level action. Depending on whether the action requested by the user account is a low risk level action, medium risk level action, or a high risk level action, different ones of the one or more step-up authentication methods may be utilized or required. For example, the fraud prevention system 320 may receive a password from the user device 402 and compare it to known passwords associated with the account can be sufficient for a low risk level action, whereas silent mobile authentication may be required for a high risk level action such as a funds transfer request. As explained above, if a known user device 402 or near field communication enabled card is new, one of the one or more step-up authentication methods may be preferred over a different one of the one or more step-up authentication methods. The fraud prevention system 320 may use machine learning models to categorize the different actions into the different levels as outlined above, and the machine learning model can determine the best one of the one or more step-up authentication method that should be utilized depending on the action risk level and the history of the telephone numbers, known user devices 402, and near field communication enabled cards associated with the account. For example, if the machine learning model selects one time passwords as an authentication method and the authentication with the fraud prevention system 320 fails due to the user device 402 being inaccessible or outside of the country, the machine learning model may determine one or more different step up authentication method.

In block 114, the fraud prevention system 320 may receive, via the user device 402, a funds transfer request. The fraud prevention system 320 may also determine whether the funds transfer request exceeds an amount threshold. Then the fraud prevention system 320, in response to determining that the funds transfer request exceeds the amount threshold, may proceed to block 116. The funds transfer request is risker because funds may be moved out of the account of the user. If the funds transfer request is less than the amount threshold, the funds transfer request is less risky. If the funds transfer request is greater than the amount threshold, the funds transfer request is risker, therefore a second step-up authentication method should be required. The amount threshold may be predetermined and set by a service provider. A second step-up authentication method may be required if a different action that is risky is requested by the user device 402 as well. A risk level may be assigned to different actions that may be taken with the account of the user. The requirement of a second step-up authentication may be required depending on the risk level assigned to each action that may be taken with the account of the user.

In optional block 115, the fraud prevention system 320 may determine a second step-up authentication method based on the geolocation of the user device 402, the funds transfer request, the first step-up authentication method, or combinations thereof. The fraud prevention system 320 may utilize one or more machine learning trained to select an appropriate authentication method from among two or more authentication methods described below by providing the one or more machine learning models with data representing successful and unsuccessful authentication methods based on geolocations, funds transfer requests, the first step-up authentication method, or combinations thereof. The fraud prevention system 320 may utilize one or more machine learning trained to select an appropriate authentication method from among two or more authentication methods described below. For example, if a user is outside of a known customer geographic region, considering that the user sent a funds transfer request, which is a higher risk action, the fraud prevention system 320 may decide that requesting a known password associated with the account may not provide the appropriate level of security desired. Similarly, one-time password verification may be difficult, limited, or undesired due to the higher risk associated with funds transfer requests. Therefore, the fraud prevention system 320 may refrain from selecting the one-time password verification as a first step-up authentication method due to these limitations and instead select another step-up authentication method described herein. Similarly, if a user device 402 is outside of the country, the user may have limited access to a known email addresses associated with the account of the user. The fraud prevention system 320 may determine that due to the geolocation of the user device 402, email verification should not be selected as the first step-up authentication method. In other examples, due to the high risk nature of the funds transfer request, depending on the geolocation of the user device 402, the fraud prevention system 320 may select email verification as the first step-up authentication method. For example, if the user device 402 is still within the country, but not within a known customer geographic region, the fraud prevention system 320 may select email verification as the first step-up authentication method because 1) the user may still have access to the known email address, or 2) there is less risk with using email verification considering the user device 402 is still within the country. In some examples, using near field communication verification, mobile application verification, or silent mobile authentication as outlined below in block 108 may be more desirable based on the geolocation of the user device 402 and the funds transfer request. In this example, if the geolocation of the user device 402 is outside of the country and considering that the current action the user is completing is a funds transfer request, which is a higher risk level, the fraud prevention system 320 may select or recommend to the user, either the near field communication verification, the mobile application verification, the silent mobile authentication, or any combinations thereof.

In block 116, the fraud prevention system 320 may transmit a request for a second step-up authentication information to the user device 402 when the funds transfer request exceeds an amount threshold. The request is sent in order to confirm that the user is authorized to complete the risker action such as the funds transfer request. The second step-up authentication information may include any data that may be used to verify the user's true identity. The second step-up authentication information may differ from the first step-up authentication method to further confirm the identity of the user as explained below in block 118.

In block 118, the fraud prevention system 320 may receive, via the user device 402, the second step-up authentication information using the one or more step-up authentication methods. The fraud prevention system 320 may then determine whether the second step-up authentication information matches known second step-up authentication information. If the second step-up authentication information matches known second step-up authentication information, similar to how the first step-up authentication information is matched against known first step-up authentication information in block 110, then the fraud prevention system 320 may proceed to block 120. If the fraud prevention system 320 determines that the second step-up authentication information does not match known second step-up authentication information, the fraud prevention system 320 may block or terminate the action requested from the user device 402, such as the funds transfer request. The second step-up authentication information is similar to the first step-up authentication information as explained above in blocks 108 and 110. Additionally, the one or more step-up authentication methods may include the same verification methods explained in block 108 and are not repeated here for brevity. If one of the one or more step-up authentication methods were used with the first step-up authentication information, then a different one of the one or more step-up authentication methods may be used with the second step-up authentication information.

In block 120, the fraud prevention system 320 may authorize the user device 402 to transfer funds in the account of the user when the second step-up authentication information matches known second step-up authentication information. If the fraud prevention system 320 authorizes the user device 402 to complete the action requested such as the transfer of funds in the account, then the user device 402 may be permitted to take other actions with the account with the same risk level. If the user device 402 attempts to do a higher level action that is risker, a third step-up authentication method may be required. If a third step-up authentication method is required, the fraud prevention system 320 may transmit a request for a third step-up authentication information to the user device 402; receive, via the user device 402, the third step-up authentication information using one or more step-up authentication methods; determine whether the third step-up authentication information matches known third step-up authentication information; responsive to determining that the third step-up authentication information matches a known third step-up authentication information, authorize the user device 402 to complete the requested action. This process is similar to the first step-up authentication information outlined above in blocks 108, 110, and 112 above, which are not repeated here for brevity.

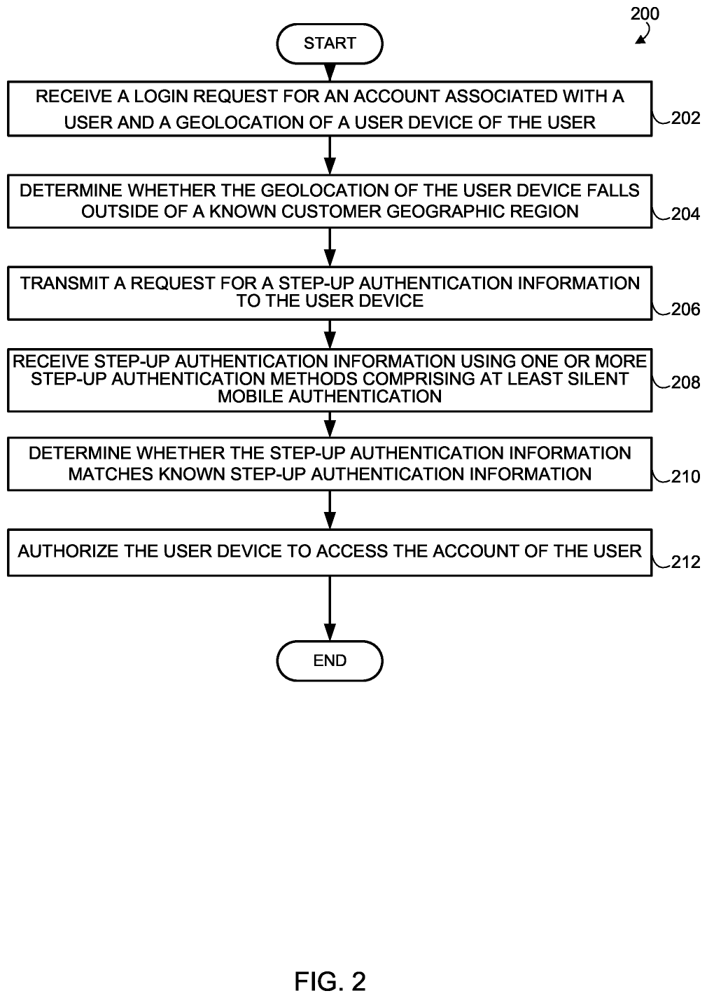

FIG. 2 is a flow diagram illustrating an exemplary method 200 for fraud prevention, in accordance with certain embodiments of the disclosed technology. The steps of method 200 may be performed by one or more components of the system 400 (e.g., fraud prevention system 320 or web server 410 of prevention system 408 or user device 402), as described in more detail with respect to FIGS. 3 and 4.

Method 200 of FIG. 2 is similar to method 100 of FIGS. 1A and 1B, except that method 200 may not include blocks 105, 111, 114, 115, 116, 118, and 120 of method 100. The descriptions of blocks 202, 204, 206, 208, 210, and 212 in method 200 are similar to the respective descriptions of blocks 102, 104, 106, 108, 110, and 112 of method 100 and are not repeated herein for brevity. However, block 212 is different from block 112 and is described below.

In block 212, the fraud prevention system 320 may also authorize the user device 402 to access the account of the user. However, in this example, the user does not request to complete an action with the account that has a high risk level as described in block 112. If the user takes lower risk actions such as checking the account balance or transactions related to the account, then additional verification methods are not required, and the fraud prevention system 320 may terminate after block 212.

FIG. 3 is a block diagram of an example fraud prevention system 320 used to prevent fraud according to an example implementation of the disclosed technology. According to some embodiments, the user device 402 and web server 410, as depicted in FIG. 4 and described below, may have a similar structure and components that are similar to those described with respect to fraud prevention system 320 shown in FIG. 3. As shown, the fraud prevention system 320 may include a processor 310, an input/output (I/O) device 370, a memory 330 containing an operating system (OS) 340 and a program 350. In certain example implementations, the fraud prevention system 320 may be a single server or may be configured as a distributed computer system including multiple servers or computers that interoperate to perform one or more of the processes and functionalities associated with the disclosed embodiments. In some embodiments fraud prevention system 320 may be one or more servers from a serverless or scaling server system. In some embodiments, the fraud prevention system 320 may further include a peripheral interface, a transceiver, a mobile network interface in communication with the processor 310, a bus configured to facilitate communication between the various components of the fraud prevention system 320, and a power source configured to power one or more components of the fraud prevention system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the fraud prevention system 320 may include one or more storage devices configured to store information used by the processor 310 (or other components) to perform certain functions related to the disclosed embodiments. In one example, the fraud prevention system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The fraud prevention system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the fraud prevention system 320 may include the memory 330 that may include one or more programs 350 to perform one or more functions of the disclosed embodiments. For example, in some embodiments, the fraud prevention system 320 may additionally manage dialogue and/or other interactions with the customer via a program 350.

The processor 310 may execute one or more programs 350 located remotely from the fraud prevention system 320. For example, the fraud prevention system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a fraud prevention system database 360 for storing related data to enable the fraud prevention system 320 to perform one or more of the processes and functionalities associated with the disclosed embodiments.

The fraud prevention system database 360 may include stored data relating to status data (e.g., average session duration data, location data, idle time between sessions, and/or average idle time between sessions) and historical status data. According to some embodiments, the functions provided by the fraud prevention system database 360 may also be provided by a database that is external to the fraud prevention system 320, such as the database 416 as shown in FIG. 4.

The fraud prevention system 320 may also be communicatively connected to one or more memory devices (e.g., databases) locally or through a network. The remote memory devices may be configured to store information and may be accessed and/or managed by the fraud prevention system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The fraud prevention system 320 may also include one or more I/O devices 370 that may comprise one or more interfaces for receiving signals or input from devices and providing signals or output to one or more devices that allow data to be received and/or transmitted by the fraud prevention system 320. For example, the fraud prevention system 320 may include interface components, which may provide interfaces to one or more input devices, such as one or more keyboards, mouse devices, touch screens, track pads, trackballs, scroll wheels, digital cameras, microphones, sensors, and the like, that enable the fraud prevention system 320 to receive data from a user (such as, for example, via the user device 402).

In examples of the disclosed technology, the fraud prevention system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The fraud prevention system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The fraud prevention system 320 may be configured to adjust model parameters during training. Model parameters may include weights, coefficients, offsets, or the like. Training may be supervised or unsupervised.

The fraud prevention system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The fraud prevention system 320 may be configured to optimize statistical models using known optimization techniques. The machine learning model may be used to assign action risk levels and to decide the best one of the one or more step-up authentication method to use as described in block 112 above.

Furthermore, the fraud prevention system 320 may include programs configured to retrieve, store, and/or analyze properties of data models and datasets. For example, fraud prevention system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The fraud prevention system 320 may include algorithms to determine a data type, key-value pairs, row-column data structure, statistical distributions of information such as keys or values, or other property of a data schema may be configured to return a statistical profile of a dataset (e.g., using a data-profiling model). The fraud prevention system 320 may be configured to implement univariate and multivariate statistical methods. The fraud prevention system 320 may include a regression model, a Bayesian model, a statistical model, a linear discriminant analysis model, or other classification model configured to determine one or more descriptive metrics of a dataset. For example, fraud prevention system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The fraud prevention system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, fraud prevention system 320 may be configured to generate a similarity metric representing a measure of similarity between data in a dataset. A similarity metric may be based on a correlation, covariance matrix, a variance, a frequency of overlapping values, or other measure of statistical similarity.

The fraud prevention system 320 may be configured to generate a similarity metric based on data model output, including data model output representing a property of the data model. For example, fraud prevention system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The fraud prevention system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The fraud prevention system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, fraud prevention system 320 is configured to generate and/or train a classification model to classify a dataset, consistent with disclosed embodiments.

While the fraud prevention system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the fraud prevention system 320 may include a greater or lesser number of components than those illustrated.

FIG. 4 is a block diagram of an example system that may be used to view and interact with prevention system 408, according to an example implementation of the disclosed technology. The components and arrangements shown in FIG. 4 are not intended to limit the disclosed embodiments as the components used to implement the disclosed processes and features may vary. As shown, prevention system 408 may interact with a user device 402 via a network 406. In certain example implementations, the prevention system 408 may include a local network 412, a fraud prevention system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the prevention system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the prevention system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The prevention system 408 may be associated with and optionally controlled by one or more entities such as a business, corporation, individual, partnership, or any other entity that provides one or more of goods, services, and consultations to individuals such as customers. In some embodiments, the prevention system 408 may be controlled by a third party on behalf of another business, corporation, individual, partnership. The prevention system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device 402 may access by providing an attempted login that are authenticated by the fraud prevention system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the prevention system 408 to interact with one another and to connect to the network 406 for interacting with components in the system 400 environment. In some embodiments, the local network 412 may include an interface for communicating with or linking to the network 406. In other embodiments, certain components of the prevention system 408 may communicate via the network 406, without a separate local network 406.

The prevention system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access prevention system 408 using the cloud computing environment. User device 402 may be able to access prevention system 408 using specialized software. The cloud computing environment may eliminate the need to install specialized software on user device 402.

In accordance with certain example implementations of the disclosed technology, the prevention system 408 may include one or more computer systems configured to compile data from a plurality of sources the fraud prevention system 320, web server 410, and/or the database 416. The fraud prevention system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

### Example Use Case

The following example use case describes an example of a typical user flow pattern. This section is intended solely for explanatory purposes and not in limitation.

In one example, a customer John is traveling outside of the country with his cell phone, a user device 402. John needs to check the balance on his account in order to complete a purchase outside of the country. The accounts may be held by a banking company. Company, the banking company can offer online services that John can utilize to complete the funds transfer request. To gain access to the account, John may send a login request for his account to the fraud prevention system 320 along with the geolocation of John's cell phone. The fraud prevention system 320 can then determine whether the geolocation of the John's cell phone falls outside of a known customer geographic region. Because John is outside of the country, John's cell phone geolocation is not within a known customer geographic region. In responsive to determining the geolocation of the cell phone falls outside of the known customer geographic region, the fraud prevention system 320 may select/determine one or more first step-up authentication methods and transmit a request for a first step-up authentication information associated with the one or more step-up authentication methods to John's cell phone, receive, via the cell phone, the first step-up authentication information using one or more step-up authentication methods, and determine whether the first step-up authentication information matches known first step-up authentication information. In response to determining that the first step-up authentication information matches a known first step-up authentication information, the fraud prevention system 320 may authorize the user device 402 to access the account of the user. Because John only wishes to check the balance of his account, the fraud prevention system 320, utilizing a machine learning model, may decide that a second step-up authentication method is not necessary.

In a different example, a customer John is traveling outside of the country with his cell phone, a user device 402. John needs to transfer funds out of his account in order to complete a purchase outside of the country. The accounts may be held by a banking company. Company, the banking company can offer online services that John can utilize to complete the funds transfer request. To gain access to the account, John may send a login request for his account to the fraud prevention system 320 along with the geolocation of John's cell phone. The fraud prevention system 320 can then determine whether the geolocation of the John's cell phone falls outside of a known customer geographic region. Because John is outside of the country, John's cell phone geolocation is not within a known customer geographic region. In responsive to determining the geolocation of the cell phone falls outside of the known customer geographic region, the fraud prevention system 320 may select/determine one or more first step-up authentication methods and transmit a request for a first step-up authentication information, associated with the one or more step-up authentication methods, to John's cell phone, receive, via the cell phone, the first step-up authentication information using one or more step-up authentication methods, and determine whether the first step-up authentication information matches known first step-up authentication information. In response to determining that the first step-up authentication information matches a known first step-up authentication information, the fraud prevention system 320 may authorize the user device 402 to access the account of the user. Because John wishes to transfer funds out of his account, the fraud prevention system 320 utilizing a machine learning model, may decide that a second step-up authentication method is necessary. The fraud prevention system 320 may select/determine one or more authentication methods and transmit a request for a second step-up authentication information, associated with one or more authentication methods, to John's cell phone, receive, via the cell phone, the second step-up authentication information using one or more step-up authentication methods, and determine whether the second step-up authentication information matches known second step-up authentication information. In response to determining that the second step-up authentication information matches a known second step-up authentication information, the fraud prevention system 320 may authorize the transfer of funds out of the account of John.

In some examples, disclosed systems or methods may involve one or more of the following clauses:

Clause 1: A fraud prevention system comprising: one or more processors; and memory in communication with the one or more processors and storing instructions that, when executed by the one or more processors, are configured to cause the fraud prevention system to: receive, via a user device, a login request for an account associated with a user and a geolocation of the user device; determine whether the geolocation of the user device falls outside of a known customer geographic region; responsive to determining that the geolocation is not outside of a known customer geographic region, authorize the user device to access the account of the user based on the login request; and responsive to determining the geolocation of the user falls outside of the known customer geographic region: transmit a request for a first step-up authentication information to the user device; receive, via the user device, the first step-up authentication information using one or more step-up authentication methods; determine whether the first step-up authentication information matches known first step-up authentication information; responsive to determining that the first step-up authentication information matches a known first step-up authentication information, authorize the user device to access the account of the user; responsive to authorizing the user device to access the account of the user: receive, via the user device, a funds transfer request; determining whether the funds transfer request exceeds an amount threshold; responsive to determining that the funds transfer request exceeds the amount threshold: transmit a request for a second step-up authentication information to the user device; receive, via the user device, the second step-up authentication information using the one or more step-up authentication methods; determine whether the second step-up authentication information matches known second step-up authentication information; and responsive to determining that the second step-up authentication information matches known second step-up authentication information, authorize the user device to transfer funds in the account of the user.

Clause 2: The fraud prevention system of clause 1, wherein the one or more step-up authentication methods comprise verification with a near field communication enabled card, mobile application verification, email verification, or combinations thereof.

Clause 3: The fraud prevention system of clause 2, wherein the one or more step-up authentication methods comprise verification with the near field communication enabled card when the near field communication enabled card contacts a near field communication receiving portion of the user device.

Clause 4: The fraud prevention system of clause 2, wherein the one or more step-up authentication methods further comprise silent mobile authentication, the silent mobile authentication comprising: receiving a telephone number of the user device, and determining whether the telephone number matches a phone number associated with the user.

Clause 5: The fraud prevention system of clause 2, wherein the one or more step-up authentication methods further comprise mobile application verification, the mobile application verification comprising: sending a notification to a known user device of the user, the notification comprising a request to authorize access of the account by the user device; receiving a response from the known user device to the request to authorize access of the account; responsive to determining that the response denies access of the account by the user device, deny the user device to access to the account of the user; and responsive to determining that the response authorizes access of the account by the user device, authorize the user device to access the account of the user.

Clause 6: The fraud prevention system of clause 2, wherein the one or more step-up authentication methods further comprise email verification, the email verification comprising: sending an email to an email address of the user, the email comprising a request to authorize access of the account by the user device; receiving a response from the email address to the request to authorize access of the account; responsive to determining that the response denies access of the account by the user device, deny the user device to access to the account of the user; and responsive to determining that the response authorizes access of the account by the user device, authorize the user device to access the account of the user.

Clause 7: The fraud prevention system of clause 1, wherein the user device is authorized to access the account of the user for a predetermined period of time.

Clause 8: A fraud prevention system comprising: one or more processors; and memory in communication with the one or more processors and storing instructions that, when executed by the one or more processors, are configured to cause the fraud prevention system to: receive, via a user device, a login request for an account associated with a user and a geolocation of the user device; determine whether the geolocation of the user device falls outside of a known customer geographic region; responsive to determining that the geolocation is not outside of a known customer geographic region, authorize the user device to access the account of the user based on the login request; and responsive to determining the geolocation of the user falls outside of the known customer geographic region: transmit a request for a step-up authentication information to the user device; receive, via the user device, set-up authentication information using one or more step-up authentication methods; determine whether the step-up authentication information matches known step-up authentication information; and responsive to determining that the step-up authentication information matches known step-up authentication information, authorize the user device to access the account of the user.

Clause 9: The fraud prevention system of clause 8, further comprising instructions configured to cause the system to: receive, via the user device, a funds transfer request; determine whether the funds transfer request exceeds an amount threshold; responsive to determining that the funds transfer request exceeds the amount threshold: transmit a request for a second step-up authentication information to the user device; receive, via the user device, the second step-up authentication information using the one or more step-up authentication methods; determine whether the second step-up authentication information matches known second step-up authentication information; and responsive to determining that the second step-up authentication information matches known second step-up authentication information, authorize the user device to transfer funds in the account of the user.

Clause 10: The fraud prevention system of clause 8, further comprising instructions configured to cause the system to: determine whether a second step-up authentication method is required, wherein determining whether a second step-up authentication method is required comprises: receive, via the user device, an action request; determine whether the action request is associated with additional step-up authentication; responsive to determining that the action requires is associated with additional step-up authentication: transmit a request for a second step-up authentication information to the user device; receive, via the user device, the second step-up authentication information using the one or more step-up authentication methods; determine whether the second step-up authentication information matches known second step-up authentication information; responsive to determining that the second step-up authentication information matches known second step-up authentication information, generate a score level based on the action request and the used step-up authentication method; determine whether to authorize the action request by comparing the score level to a predetermined threshold; responsive to determining that the score level is above the predetermined threshold, deny the action request; and responsive to determining that the score level is equal to or below the predetermined threshold, authorize the action request.

Clause 11: The fraud prevention system of clause 8, wherein the one or more step-up authentication methods comprise verification with a near field communication enabled card, mobile application verification, email verification, or combinations thereof.

Clause 12: The fraud prevention system of clause 11, wherein the one or more step-up authentication methods comprise verification with the near field communication enabled card when the near field communication enabled card contacts a near field communication receiving portion of the user device.

Clause 13: The fraud prevention system of clause 8, wherein the one or more step-up authentication methods further comprise silent mobile authentication, the silent mobile authentication comprising: receiving a telephone number of the user device, and determining whether the telephone number matches a phone number associated with the user.

Clause 14: The fraud prevention system of clause 8, wherein the one or more step-up authentication methods further comprise mobile application verification, the mobile application verification comprising: sending a notification to a known user device of the user, the notification comprising a request to authorize access of the account by the user device; receiving a response from the known user device to the request to authorize access of the account; responsive to determining that the response denies access of the account by the user device, deny the user device to access to the account of the user; and responsive to determining that the response authorizes access of the account by the user device, authorize the user device to access the account of the user.

Clause 15: The fraud prevention system of clause 8, wherein the one or more step-up authentication methods further comprise email verification, the email verification comprising: sending an email to an email address of the user, the email comprising a request to authorize access of the account by the user device; receiving a response from the email address to the request to authorize access of the account; responsive to determining that the response denies access of the account by the user device, deny the user device to access to the account of the user; and responsive to determining that the response authorizes access of the account by the user device, authorize the user device to access the account of the user.

Clause 16: The fraud prevention system of clause 8, further comprising instructions configured to cause the system to select, via one or more machine learning models, a step-up authentication method from one or more step-up authentication methods based on the geolocation of the user device and the login request and responsive to determining the geolocation of the user falls outside of the known customer geographic region, wherein the step-up authentication information is associated with the selected step-up authentication method.

Clause 17: A method for preventing fraud, comprising: receiving a login request for an account associated with a user and a geolocation of a user device of the user; determining a geolocation of the user device falls outside of a known customer geographic region; transmitting a request for a step-up authentication information to the user device; receiving set-up authentication information using one or more step-up authentication methods comprising at least silent mobile authentication; determining whether the step-up authentication information matches known step-up authentication information; and responsive to determining that the step-up authentication information matches known step-up authentication information, authorizing the user device to access the account of the user.

Clause 18: The method of clause 17, further comprising: receiving, via the user device, a funds transfer request; transmitting a request for a second step-up authentication information to the user device; receiving, via the user device, the second step-up authentication information using the one or more step-up authentication methods; determining whether the second step-up authentication information matches known second step-up authentication information; and responsive to determining that the second step-up authentication information matches known second step-up authentication information, authorizing the user device to transfer funds in the account of the user.

Clause 19: The method of clause 17, wherein the one or more step-up authentication methods comprise verification with a near field communication enabled card, mobile application verification, email verification, or combinations thereof.

Clause 20: The method of clause 19, wherein the one or more step-up authentication methods comprise verification with the near field communication enabled card when the near field communication enabled card contacts a near field communication receiving portion of the user device.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fraud prevention system comprising:
one or more processors; and
memory in communication with the one or more processors and storing instructions that, when executed by the one or more processors, are configured to cause the fraud prevention system to:
receive, via a user device, a login request for an account associated with a user and a geolocation of the user device;
determine whether the geolocation of the user device falls outside of a known customer geographic region;
responsive to determining that the geolocation is not outside of a known customer geographic region, authorize the user device to access the account of the user based on the login request; and
responsive to determining the geolocation of the user falls outside of the known customer geographic region:
transmit a request for a first step-up authentication information to the user device;
receive, via the user device, the first step-up authentication information using one or more step-up authentication methods;
determine whether the first step-up authentication information matches known first step-up authentication information;
responsive to determining that the first step-up authentication information matches a known first step-up authentication information, authorize the user device to access the account of the user;
responsive to authorizing the user device to access the account of the user:
receive, via the user device, a funds transfer request;
determining whether the funds transfer request exceeds an amount threshold;
responsive to determining that the funds transfer request exceeds the amount threshold:
transmit a request for a second step-up authentication information to the user device;
receive, via the user device, the second step-up authentication information using the one or more step-up authentication methods;
determine whether the second step-up authentication information matches known second step-up authentication information; and
responsive to determining that the second step-up authentication information matches known second step-up authentication information, authorize the user device to transfer funds in the account of the user.

2. The fraud prevention system of claim 1, wherein the one or more step-up authentication methods comprise verification with a near field communication enabled card, mobile application verification, email verification, or combinations thereof.

3. The fraud prevention system of claim 2, wherein the one or more step-up authentication methods comprise verification with the near field communication enabled card when the near field communication enabled card contacts a near field communication receiving portion of the user device.

4. The fraud prevention system of claim 2, wherein the one or more step-up authentication methods further comprise silent mobile authentication, the silent mobile authentication comprising:
receiving a telephone number of the user device, and
determining whether the telephone number matches a phone number associated with the user.

5. The fraud prevention system of claim 2, wherein the one or more step-up authentication methods further comprise mobile application verification, the mobile application verification comprising:
sending a notification to a known user device of the user, the notification comprising a request to authorize access of the account by the user device;
receiving a response from the known user device to the request to authorize access of the account;
responsive to determining that the response denies access of the account by the user device, deny the user device to access to the account of the user; and
responsive to determining that the response authorizes access of the account by the user device, authorize the user device to access the account of the user.

6. The fraud prevention system of claim 2, wherein the one or more step-up authentication methods further comprise email verification, the email verification comprising:
sending an email to an email address of the user, the email comprising a request to authorize access of the account by the user device;
receiving a response from the email address to the request to authorize access of the account;
responsive to determining that the response denies access of the account by the user device, deny the user device to access to the account of the user; and
responsive to determining that the response authorizes access of the account by the user device, authorize the user device to access the account of the user.

7. The fraud prevention system of claim 1, wherein the user device is authorized to access the account of the user for a predetermined period of time.

8. A fraud prevention system comprising:
one or more processors; and
memory in communication with the one or more processors and storing instructions that, when executed by the one or more processors, are configured to cause the fraud prevention system to:
receive, via a user device, a login request for an account associated with a user and a geolocation of the user device;
determine whether the geolocation of the user device falls outside of a known customer geographic region;
responsive to determining that the geolocation is not outside of a known customer geographic region, authorize the user device to access the account of the user based on the login request; and
responsive to determining the geolocation of the user falls outside of the known customer geographic region:
transmit a request for a step-up authentication information to the user device;
receive, via the user device, set-up authentication information using one or more step-up authentication methods;
determine whether the step-up authentication information matches known step-up authentication information; and
responsive to determining that the step-up authentication information matches known step-up authentication information, authorize the user device to access the account of the user.

9. The fraud prevention system of claim 8, further comprising instructions configured to cause the system to:
receive, via the user device, a funds transfer request;
determine whether the funds transfer request exceeds an amount threshold;
responsive to determining that the funds transfer request exceeds the amount threshold:
transmit a request for a second step-up authentication information to the user device;
receive, via the user device, the second step-up authentication information using the one or more step-up authentication methods;
determine whether the second step-up authentication information matches known second step-up authentication information; and
responsive to determining that the second step-up authentication information matches known second step-up authentication information, authorize the user device to transfer funds in the account of the user.

10. The fraud prevention system of claim 8, further comprising instructions configured to cause the system to:
determine whether a second step-up authentication method is required, wherein determining whether a second step-up authentication method is required comprises:
receive, via the user device, an action request;
determine whether the action request is associated with additional step-up authentication;
responsive to determining that the action requires is associated with additional step-up authentication:
transmit a request for a second step-up authentication information to the user device;
receive, via the user device, the second step-up authentication information using the one or more step-up authentication methods;
determine whether the second step-up authentication information matches known second step-up authentication information;
responsive to determining that the second step-up authentication information matches known second step-up authentication information, generate a score level based on the action request and the used step-up authentication method;
determine whether to authorize the action request by comparing the score level to a predetermined threshold;
responsive to determining that the score level is above the predetermined threshold, deny the action request; and
responsive to determining that the score level is equal to or below the predetermined threshold, authorize the action request.

11. The fraud prevention system of claim 8, wherein the one or more step-up authentication methods comprise verification with a near field communication enabled card, mobile application verification, email verification, or combinations thereof.

12. The fraud prevention system of claim 11, wherein the one or more step-up authentication methods comprise verification with the near field communication enabled card when the near field communication enabled card contacts a near field communication receiving portion of the user device.

13. The fraud prevention system of claim 8, wherein the one or more step-up authentication methods further comprise silent mobile authentication, the silent mobile authentication comprising:
receiving a telephone number of the user device, and
determining whether the telephone number matches a phone number associated with the user.

14. The fraud prevention system of claim 8, wherein the one or more step-up authentication methods further comprise mobile application verification, the mobile application verification comprising:
sending a notification to a known user device of the user, the notification comprising a request to authorize access of the account by the user device;
receiving a response from the known user device to the request to authorize access of the account;
responsive to determining that the response denies access of the account by the user device, deny the user device to access to the account of the user; and
responsive to determining that the response authorizes access of the account by the user device, authorize the user device to access the account of the user.

15. The fraud prevention system of claim 8, wherein the one or more step-up authentication methods further comprise email verification, the email verification comprising:
sending an email to an email address of the user, the email comprising a request to authorize access of the account by the user device;
receiving a response from the email address to the request to authorize access of the account;
responsive to determining that the response denies access of the account by the user device, deny the user device to access to the account of the user; and
responsive to determining that the response authorizes access of the account by the user device, authorize the user device to access the account of the user.

16. The fraud prevention system of claim 8, further comprising instructions configured to cause the system to select, via one or more machine learning models, a step-up authentication method from one or more step-up authentication methods based on the geolocation of the user device and the login request and responsive to determining the geolocation of the user falls outside of the known customer geographic region,
wherein the step-up authentication information is associated with the selected step-up authentication method.

17. A method for preventing fraud, comprising:
receiving a login request for an account associated with a user and a geolocation of a user device of the user;
determining a geolocation of the user device falls outside of a known customer geographic region;
transmitting a request for a step-up authentication information to the user device;
receiving set-up authentication information using one or more step-up authentication methods comprising at least silent mobile authentication;
determining whether the step-up authentication information matches known step-up authentication information; and
responsive to determining that the step-up authentication information matches known step-up authentication information, authorizing the user device to access the account of the user.

18. The method of claim 17, further comprising:
receiving, via the user device, a funds transfer request;
transmitting a request for a second step-up authentication information to the user device;
receiving, via the user device, the second step-up authentication information using the one or more step-up authentication methods;
determining whether the second step-up authentication information matches known second step-up authentication information; and
responsive to determining that the second step-up authentication information matches known second step-up authentication information, authorizing the user device to transfer funds in the account of the user.

19. The method of claim 17, wherein the one or more step-up authentication methods comprise verification with a near field communication enabled card, mobile application verification, email verification, or combinations thereof.

20. The method of claim 19, wherein the one or more step-up authentication methods comprise verification with the near field communication enabled card when the near field communication enabled card contacts a near field communication receiving portion of the user device.
